(19) United States
(12) Patent Application Publication
(10) Pub. No.: US 2005/0114695 A1
(43) Pub. Date: May 26, 2005

(54) Anti-theft device for mobile electronic devices

(75) Inventor: Rudiger Landto, Graben (DE)

Correspondence Address: COHEN, PONTANI, LIEBERMAN & PAVANE, 551 FIFTH AVENUE, SUITE 1210, NEW YORK, NY, 10176, US

(73) Assignee: Fujitsu Siemens Computers GmbH, Munchen (DE)

(21) Appl. No.: 10/966,804

(22) Filed: Oct. 15, 2004

Related U.S. Application Data
(63) Continuation of application No. PCT/DE03/00816, filed on Mar. 13, 2003.

(30) Foreign Application Priority Data
Apr. 19, 2002 (DE) 102 17 582.9

(51) Int. Cl. H04L 9/00; H04L 9/32

(52) U.S. Cl. 713/200

(57) ABSTRACT

A method for protecting mobile electronic devices, such as personal computers or mobile PDAs, against theft or unauthorized use by using a time-switch device. In addition to the conventional log-in protection with a password, operation of the electronic device is blocked by a time-switch device after a defined time period has elapsed. The time-switch device can only be unblocked and the time period reset with manual presentation of a unique identification means which releases the electronic device for further operation.

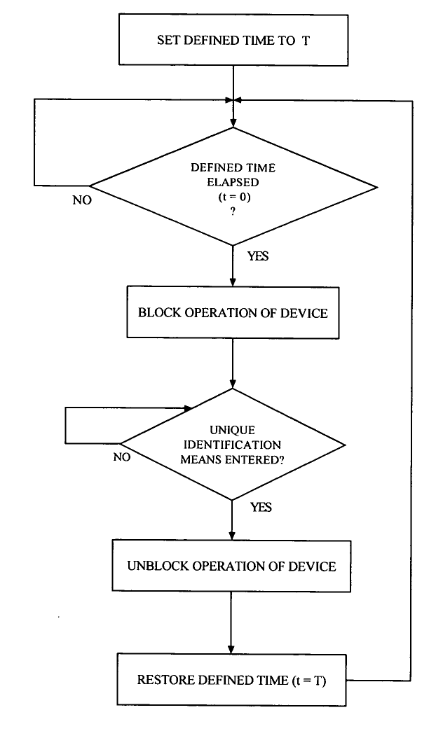

### CROSS-REFERENCE TO RELATED APPLICATION

This is a continuation of International Application No. PCT/DE2003/000816, filed on Mar. 13, 2003, which claims priority from German Patent Application No. 102 17 582.9, filed on Apr. 19, 2002 the content of which is hereby incorporated by reference.

### FIELD OF THE INVENTION

The invention relates to a method for protecting electronic equipment against theft or unauthorized use, using a time-switch device in conjunction with a unique identification means, especially for mobile equipment such as mobile personal computers or PDAs.

### BACKGROUND OF THE INVENTION

In educational establishments, for example, electronic data processing equipment is sometimes loaned to participants of an educational organization. In that situation a simple password has conventionally been used as protection against theft. The password was known to the respective user and only acted as protection against theft if the electronic equipment with password was not deliberately passed on to a third party by the borrower.

The document “Method and Apparatus for Conveniently Resetting Electronic Log of Computer system” (IBM Technical Disclosure Bulletin, Vol. 36, No. 8) discloses a method in which an automatic shutdown of a computer system is interrupted by the user of the computer system executing an interaction, for example, a mouse click, a movement of the mouse, a sound input or hitting a keyboard. The time interval after which the next shutdown of the computer system will be initiated is reset upon interruption of the shutdown.

U.S. Pat. No. 5,699,514 describes an access control system which stores two codes for each user that is authorized to access a resource, a primary code and a secondary code. When a user desiring access inputs the primary code to the system, the code is compared with the stored code for that user. If the primary code is valid, the user is allowed to access the resource. However, if the primary code is entered incorrectly, a count of the number of invalid attempts for that user is incremented, and if the count does not exceed a first threshold, the user can try again. When the number of invalid access attempts for the user exceeds the first threshold, the system requires the user to correctly input both the primary and secondary codes, before access to the resource is allowed.

U.S. Pat. No. 6,014,746 discloses a security system in which access to a workstation or to data media and the theft of data or data media is prevented by a security signal, for example, an alarm sounding when unauthorized access is detected. An alarm also sounds if too many incorrect passwords have been entered, the program of the security system has been interrupted or the power supply has been interrupted.

### SUMMARY OF THE INVENTION

One object of the invention is to provide protection for a portable device against theft or unauthorized use, such as for an electronic device or a computer which is to be loaned out, which makes the device unusable by the borrower or third persons after a loan period has elapsed.

This and other objects are attained in accordance with one aspect of the present invention directed to a method for protecting portable devices, such as personal computers or PDAs, against theft or unauthorized use by using a time-switch device. Operation of the device is enabled during a defined time period. After the defined time period has elapsed, operation of the device is blocked by the time-switch device. The time-switch device can unblock the device for further operation only with a unique identification means.

The blocked device can only be re-activated by that person to whom the unique identification means, for example, a password, of the time-switch device is known. In one variation, this is not the borrower himself but an authorized representative of the educational establishment. The time-switch device is reset back to an initial state by the unique identification means.

The time-switch device is configured by the authorized representative of the educational establishment which is loaning the device, and is protected by the unique identification means, for example, a password. When the end of the defined time period is reached, it becomes impossible to operate the equipment as a result of a block, and the user or the borrower can no longer use the equipment. The equipment must be submitted to the authorized representative of the educational establishment for unblocking.

The method protection against theft for mobile electronic equipment can advantageously by implemented and improved by integrating the time-switch device in various areas of the equipment. For this purpose it is possible to:
1. integrate the time-switch device in the equipment's own BIOS,
2. integrate the time-switch device in the equipment's own power supply,
3. integrate the time-switch device in the operating system of the equipment.

### BRIEF DESCRIPTION OF THE DRAWINGS

The single FIGURE shows a block circuit diagram for protecting mobile electronic equipment against theft and unauthorized use in accordance with the invention.

### DETAILED DESCRIPTION OF THE DRAWINGS

The method for protecting electronic equipment against theft or unauthorized use provides a defined time period of a duration T (i.e. t=T). For the example mentioned above involving lending such a device by an educational institution duration T of the time period can be set to one or two weeks, for example. During time period T, operation of the device proceeds normally, such as after log-in with a password in a conventional manner. When the defined time period has elapsed, i.e. t=0, further operation of the device is automatically blocked. A unique identification means valid for that particular electronic device such as, for example, the presentation of a password, is required to unblock, i.e. re-activate, the electronic device. If an incorrect password is used or the identification means is unknown, the device remains blocked until the correct password is entered.

The borrower does not know the unique identification code and, therefore, cannot unblock the device. In order to be unblocked, the electronic device must then be returned by the borrower to the lender, e.g. the authorized representative of the educational establishment.

If the correct password is entered, the device is unblocked and a timer for the time-switch device is reset to T.

If the user presents a preset number of incorrect or invalid uses of unique identification means, a further time-switch device is activated which blocks the electronic device and any subsequent request for entry of a unique identification means for a defined time. This is aimed at making it more time consuming and more difficult to “hack into” the electronic device.

Countdown of the defined time period T to zero can be based on calendar time, i.e., the number of days and hours from initiation of the time period. The countdown proceeds whether or not the electronic device is operated. Alternatively, the countdown can proceed only during the time when the electronic device is operating so that time period T represents the number of days and hours for which actual operation of the device is enabled.

If the defined time period is based on calendar time as mentioned above, a specific time zone can be specified. Thus, if the user is on the east coast of the U.S., that time zone will be used. However, another time zone, such as European time may also be designated when the invention is set to operate on the device.

As a result of the method according to the invention, the electronic equipment is of no interest for illegal sale or for deliberately passing it on by the borrower to a third party without authorization. Furthermore, there is the opportunity to update the software and hardware of the device when such device is regularly submitted to the authorized representative of the educational establishment.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

1. A method for protecting portable electronic devices, such as personal computers or PDAs, against theft or unauthorized use by using a time-switch device, comprising:
enabling operation of a particular electronic device during a defined time period of duration T,
after the defined time period T has elapsed, automatically blocking operation of the electronic device by the time-switch device, and
unblocking the electronic device for further operation only when a unique identification means valid for said particular electronic device is manually presented.

2. The method according to claim 1,
wherein the time-switch device is integrated in the BIOS of the electronic device.

3. The method according to claim 1,
wherein the time-switch device is integrated in the power supply of the electronic device.

4. The method according to claim 1,
wherein the time-switch device is integrated in the operating system software of the electronic device.

5. The method according to claim 1,
wherein the unique identification means for unblocking the electronic device can only be updated when the electronic device is unblocked and with presentation of the unique identification means valid therefore.

6. The method according to claim 1,
wherein after presentation of a defined number of incorrect or invalid uses of unique identification means a further time-switch device is activated which blocks the electronic device and any further request for entry of a unique identification means for a defined time period.

7. The method according to claim 1,
wherein the unique identification means is a password.

8. The method according to claim 7,
wherein a current password can only be updated when the electronic device is unblocked and with knowledge of the current password.

9. The method according to claim 7,
wherein, after presentation of a defined number of incorrect password entries, a further time-switch device is activated which blocks interrogation of the electronic device and the password for a defined time period.

10. The method according to claim 1,
wherein the operating time of the electronic device is used as the defined time period.

11. The method according to claim 1,
wherein the date and time of a specific time zone is used as the defined time period.

12. The method according to claim 1, wherein the defined time period of the time-switch device is reset by the unique identification means.

13. The method according to claim 12, wherein the defined time period to which said time-switch device is reset has a duration T.

14. The method according to claim 1, wherein the particular portable device is loaned by its owner to a user, and wherein the method includes the retention by the owner of the unique identification means valid therefor without conveying it to the user.
